(19) United States
(12) Patent Application Publication
(10) Pub. No.: US 2009/0174306 A1
(43) Pub. Date: Jul. 9, 2009

(54) FLUORESCENT LAMP AND FABRICATION METHOD THEREOF

(75) Inventors: Chun-Hsien Yeh, Taipei City (TW); Yu-Tsai Peng, Taoyuan County (TW); Ching-Hsiang Tseng, Taoyuan County (TW); Chi-Tsan Wang, Taoyuan County (TW); Hsiang-Lin Chang, Taoyuan County (TW)

Correspondence Address: J C PATENTS, INC., 4 VENTURE, SUITE 250, IRVINE, CA, 92618, US

(73) Assignee: Sintronic Technology Inc., Hsinchu County (TW)

(21) Appl. No.: 12/325,739

(22) Filed: Dec. 1, 2008

(30) Foreign Application Priority Data
Jan. 4, 2008 (TW) 97100324

(51) Int. Cl. B29C 35/08; H01J 1/62

(52) U.S. Cl. 313/485; 264/400

(57) ABSTRACT

A fluorescent lamp including a tube, a fluorescent layer, a discharging gas and two electrodes is provided. The fluorescent layer is disposed on an inner wall of the tube. The fluorescent layer has a plurality of patterned grooves to form a serial number. The discharging gas is distributed in the tube. In addition, the electrodes are disposed at two ends of the tube.

### CROSS-REFERENCE TO RELATED APPLICATION

This application claims the priority benefit of Taiwan application serial no. 97100324, filed on Jan. 4, 2008. The entirety of the above-mentioned patent application is hereby incorporated by reference herein and made a part of specification.

### BACKGROUND OF THE INVENTION

1. Field of the Invention

The present invention generally relates to a lamp tube and a fabrication method thereof, in particular, to a fluorescent lamp and a fabrication method thereof.

2. Description of Related Art

Cold cathode fluorescent lamps are a type of low-voltage mercury electric discharge lamps. When a voltage is applied on two ends of a cold cathode fluorescent lamp, gas discharge is generated to excite mercury atoms, so as to emit UV light. When the UV light is irradiated on a fluorescent layer on a wall of the lamp tube, chromatic light is generated. As the cold cathode fluorescent lamp does not use a filament, the problem that the filament fuses will not occur, and thus the cold cathode fluorescent lamp has a very reliable service life.

Conventionally, a serial number is formed on the surface of an end of a cold cathode fluorescent lamp by ink jet printing. The serial number can be used to trace the origin, production date, and production conditions of the lamp tube. Generally, the working temperature of the lamp tube is very high, so the serial number formed by ink jet printing is likely to volatilize at the high temperature, and may become unrecognizable. If the cold cathode fluorescent lamp fails to work, the origin, production data, and production conditions of the lamp cannot be effectively traced, and even the factory cannot be recognized as well. Thus, problems in the production line cannot be effectively eliminated, and relevant responsibilities cannot be identified. In another aspect, the ink usually contains ingredients that do not conform to the environmental specification, and must be improved.

### SUMMARY OF THE INVENTION

Accordingly, the present invention is directed to a fluorescent lamp, which has a serial number formed inside the fluorescent lamp and has good durability.

The present invention is also directed to a fabrication method of a fluorescent lamp, which is capable of forming a serial number inside the fluorescent lamp.

The present invention provides a fluorescent lamp, which includes a tube, a fluorescent layer, a discharging gas, and two electrodes. The fluorescent layer is disposed on an inner wall of the tube. The fluorescent layer has a plurality of patterned grooves to form a serial number. The discharging gas is distributed in tube. In addition, the electrodes are disposed at two ends of the tube.

In an embodiment of the present invention, the serial number includes English letters.

In an embodiment of the present invention, the serial number includes Arabic numerals.

In an embodiment of the present invention, the discharging gas includes mercury vapor.

In an embodiment of the present invention, the discharging gas includes an inert gas.

In an embodiment of the present invention, the discharging gas includes argon (Ar), neon (Ne), or a mixture thereof.

The present invention provides a fabrication method of a fluorescent lamp, which includes: first, providing a fluorescent lamp, in which the fluorescent lamp has a fluorescent layer; next, patterning the fluorescent layer through a laser beam to form a plurality of patterned grooves and form a serial number.

In an embodiment of the present invention, the laser beam includes red laser.

In an embodiment of the present invention, the fluorescent lamp includes a cold cathode fluorescent lamp, a daylight lamp, or a three-wavelength compact fluorescent lamp.

The serial number of the present invention is formed by removing a part of the fluorescent layer with the laser beam. As the serial number of the present invention is formed inside the fluorescent lamp, it will not fall off due to external friction. Further, the serial number can still be clearly identified after long use of the fluorescent lamp, even if electrode blackening occurs. The fabrication method of a fluorescent lamp of the present invention can be applied to effectively produce a serial number with good durability.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A-1B are flow charts of a fabrication method of a fluorescent lamp according to an embodiment of the present invention.

FIGS. 2A-2B are cross-sectional views of the fluorescent lamps in FIGS. 1A-1B respectively.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

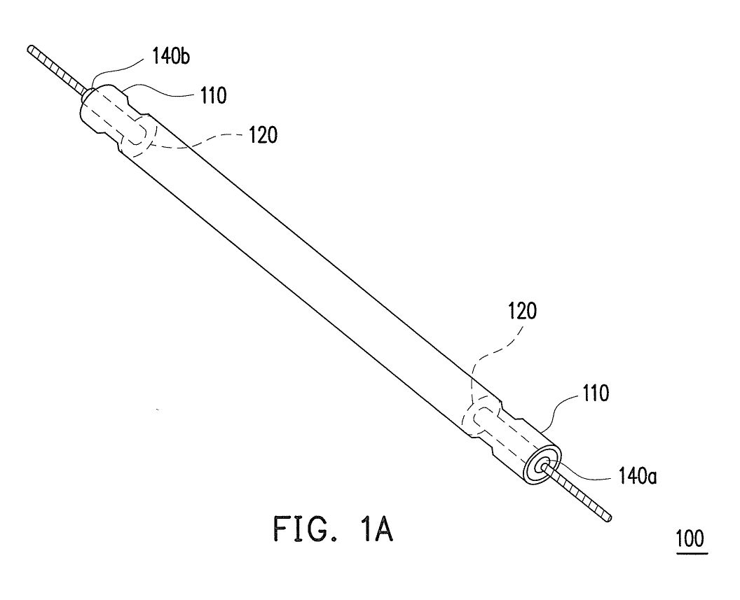

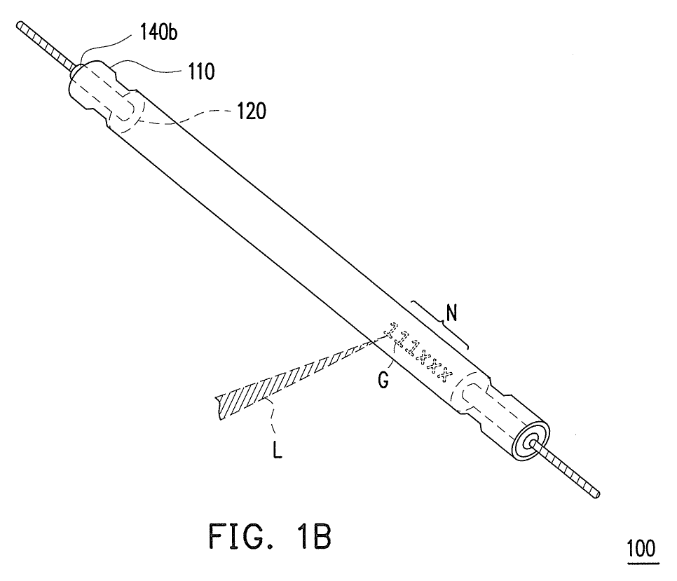

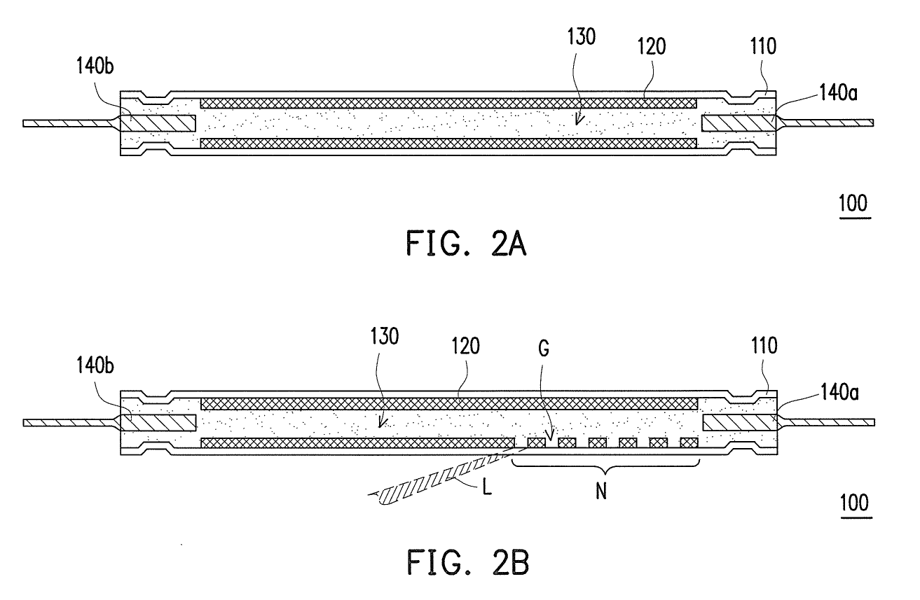

FIGS. 1A-1B are flow charts of a fabrication method of a fluorescent lamp according to an embodiment of the present invention. FIGS. 2A-2B are cross-sectional views of the fluorescent lamps in FIGS. 1A-1B respectively. Referring to FIGS. 1A and 2A, the fabrication method of a fluorescent lamp of the present invention includes the following steps. First, a fluorescent lamp 100 is provided, in which a serial number is to be formed. Generally, the fluorescent lamp 100 includes a tube 110, a fluorescent layer 120, a discharging gas 130, and two electrodes 140a, 140b. The fluorescent layer 120 is disposed on an inner wall of the tube 110. In practice, the fluorescent layer 120 can be formed by formulating fluorescent powders of various colors according to a chromatic light required by the fluorescent lamp 100. The fluorescent powder can be, for example, red, green, or blue fluorescent powder. In addition, a material of the tube 110 is, for example, soft glass or hard glass, and can also be a material absorbing UV light or not absorbing UV light.

Further, the discharging gas 130 is distributed in the tube 110. The discharging gas 130 can include mercury vapor and an inert gas. The inert gas is, for example, argon (Ar), neon (Ne), or a mixture thereof. In addition, the electrodes 140a, 140b are disposed at two ends of the tube 110. Specifically, when a voltage is applied to the electrodes 140a, 140b, electrons in the tube 110 fly from the cathode to the anode. During this process, the electrons will impact the mercury vapor in the tube 110 and excite the mercury atoms to emit UV light. When the UV light is irradiated on the fluorescent layer 120 on the inner wall of the lamp tube 110, the chromatic light is generated. Definitely, those of ordinary skills in the art should know that the fluorescent lamp 100 is merely intended to illustrate the present invention, various types of fluorescent lamps can also be used, as long as the fluorescent lamps are to have serial numbers formed therein.

Then, referring to FIGS. 1B and 2B, the fluorescent layer 120 is patterned through a laser beam L to form a plurality of patterned grooves G. The laser beam L is, for example, a red laser. In an embodiment, the laser beam L shown in FIG. 2B can be instantly focused on the fluorescent layer 120 on the inner wall of the tube 110 to remove a part of the fluorescent layer 120. Thus, the fluorescent layer 120 has a plurality of patterned grooves G and can form a serial number N in FIG. 1B. Generally, the serial number N can include, but is not limited to, English letters or Arabic numerals. The serial number can be used to trace the origin, production date, and production conditions of the lamp tube. In practice, the focusing time of the laser beam L is, for example, 0.4 second. Definitely, those of ordinary skills in the art can adjust the intensity and focusing time of the laser beam L according to the thickness of the fluorescent layer 120.

It should be emphasized herein that the fabrication method of a fluorescent lamp of the present invention is applicable for any fluorescent lamps having a fluorescent layer, for example, cold cathode fluorescent lamps, daylight lamps, or three-wavelength compact fluorescent lamps. Herein, merely the cold cathode fluorescent lamp is illustrated as an example, and those of ordinary skills in the art can apply the fabrication method of a fluorescent lamp of the present invention in various types of fluorescent lamps.

In the above, the fabrication method of a fluorescent lamp of the present invention and the fluorescent lamp have been substantially introduced. The serial number of the present invention is formed by removing a part of the fluorescent layer through a laser beam, so as to form the patterned grooves representing the serial number in the fluorescent layer. The serial number is formed inside the fluorescent lamp, so it will not fall off due to external friction. Further, the serial number can be clearly identified after long use of the fluorescent lamp, even if electrode blackening occurs. Therefore, the fabrication method of a fluorescent lamp of the present invention can be applied to effectively produce a serial number with good durability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A fluorescent lamp, comprising:
a tube;
a fluorescent layer, disposed on an inner wall of the tube, wherein the fluorescent layer comprises a plurality of patterned grooves to form a serial number;
a discharging gas, distributed in the tube; and
two electrodes, disposed at two ends of the tube respectively.

2. The fluorescent lamp according to claim 1, wherein the serial number comprises English letters.

3. The fluorescent lamp according to claim 1, wherein the serial number comprises Arabic numerals.

4. The fluorescent lamp according to claim 1, wherein the discharging gas comprises mercury vapor.

5. The fluorescent lamp according to claim 1, wherein the discharging gas comprises an inert gas.

6. The fluorescent lamp according to claim 5, wherein the discharging gas comprises argon (Ar), neon (Ne), or a mixture thereof.

7. A fabrication method of a fluorescent lamp, comprising:
providing a fluorescent lamp, wherein the fluorescent lamp comprises a fluorescent layer; and
patterning the fluorescent layer through a laser beam to form a plurality of patterned grooves and form a serial number.

8. The fabrication method of a fluorescent lamp according to claim 7, wherein the laser beam comprises a red laser.

9. The fabrication method of a fluorescent lamp according to claim 7, wherein the serial number comprises English letters.

10. The fabrication method of a fluorescent lamp according to claim 7, wherein the serial number comprises Arabic numerals.

11. The fabrication method of a fluorescent lamp according to claim 7, wherein the fluorescent lamp comprises a cold cathode fluorescent lamp, a daylight lamp, or a three-wavelength compact fluorescent lamp.
